(19) United States
(12) Patent Application Publication
(10) Pub. No.: US 2009/0245522 A1
(43) Pub. Date: Oct. 1, 2009

(54) MEMORY DEVICE

(75) Inventors: Yoshiyuki Kudo, Kawasaki (JP); Takahiro Shinbori, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/368,098

(22) Filed: Feb. 9, 2009

(30) Foreign Application Priority Data
Mar. 31, 2008 (JP) 2008-091901

(51) Int. Cl. H04L 9/08

(52) U.S. Cl. 380/280

(57) ABSTRACT

A method of controlling a memory device connectable to a host for sending out a command to the memory device, has storing a plurality of first keys which are accessible by a plurality of passwords, respectively, encrypting a second key for encrypting and decrypting data to produce an encrypted second key by using one of the first keys, and storing the encrypted second key, decrypting the encrypted second key by using one of the first keys and encrypting or decrypting data by the second key upon receipt of a command from the host to encrypt or decrypt the data, and receiving, upon receipt of a command for renewing the second key from the host, a renewed second key, encrypting the renewed second key with one of the first keys, and storing the encrypted renewed second key.

### CROSS-REFERENCE TO RELATED APPLICATION

This application is based upon and claims the benefit of priority of the prior Japanese Patent Application No. 2008-091901, filed on Mar. 31, 2008, the entire contents of which are incorporated herein by reference.

### FIELD

A certain aspect of the embodiments discussed herein is related to a memory device.

### BACKGROUND

As a memory device for storing information, a type of information storing devices for encrypting information is well-known. For example, in a hard disk drive, information externally transmitted is encrypted with an encryption key and is then stored, and the encryption key is further encrypted by a user password and is stored, thereby reading the information upon inputting a proper password. Data stored into the information storing device can be commonly used by a plurality of users and management of a password suitable to the use of a plurality of users is demanded.

Herein, in a field of a network system, such a technology is well known that a management server of a password is provided for a system sharing information by a group having a plurality of users and a group password is managed (refer to, e.g., Japanese Laid-open Patent Publication No. 2007-49455). Upon changing the user belonging to the group in the system, the management server updates the group password, and the updated group password is distributed to all users in the group.

### SUMMARY

According to an aspect of an embodiment, a method of controlling a memory device connectable to a host for sending out a command to the memory device, has storing a plurality of first keys which are accessible by a plurality of passwords, respectively, encrypting a second key for encrypting and decrypting data to produce an encrypted second key by using one of the first keys, and storing the encrypted second key, decrypting the encrypted second key by using one of the first keys and encrypting or decrypting data by the second key upon receipt of a command from the host to encrypt or decrypt the data, and receiving, upon receipt of a command for renewing the second key from the host, a renewed second key, encrypting the renewed second key with one of the first keys, and storing the encrypted renewed second key.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram showing the schematic structure of a hard disk device (HDD) as an information storing device according to the conventional art;

FIG. 2 is a flowchart showing processing for reading data in the HDD shown in FIG. 1;

FIG. 3 is a flowchart showing processing for changing a data key in the HDD shown in FIG. 1;

FIG. 4 is an explanatory diagram of a state for encrypting the data key in the HDD shown in FIG. 1;

FIG. 5 is a block diagram showing the hardware structure of an HDD as the information storing device according to the first embodiment;

FIG. 6 is a block diagram showing the schematic structure of blocks for encryption/decryption in the HDD shown in FIG. 5;

FIG. 7 is a flowchart showing processing in response to the HDD shown in FIG. 6 in response to the data reading command;

FIG. 8 is a flowchart showing processing in response to a key updating command in the HDD shown in FIG. 6;

FIG. 9 is an explanatory diagram of a state for encrypting a key in the HDD shown in FIG. 6;

FIG. 10 is a block diagram showing the schematic structure of blocks for encryption/decryption in an HDD according to the second embodiment;

FIG. 11 is a block diagram showing the schematic structure of blocks for encryption/decryption in an HDD according to the third embodiment; and

FIG. 12 is a flowchart showing processing in response to a key updating command in the HDD shown in FIG. 11.

### DESCRIPTION OF EMBODIMENTS

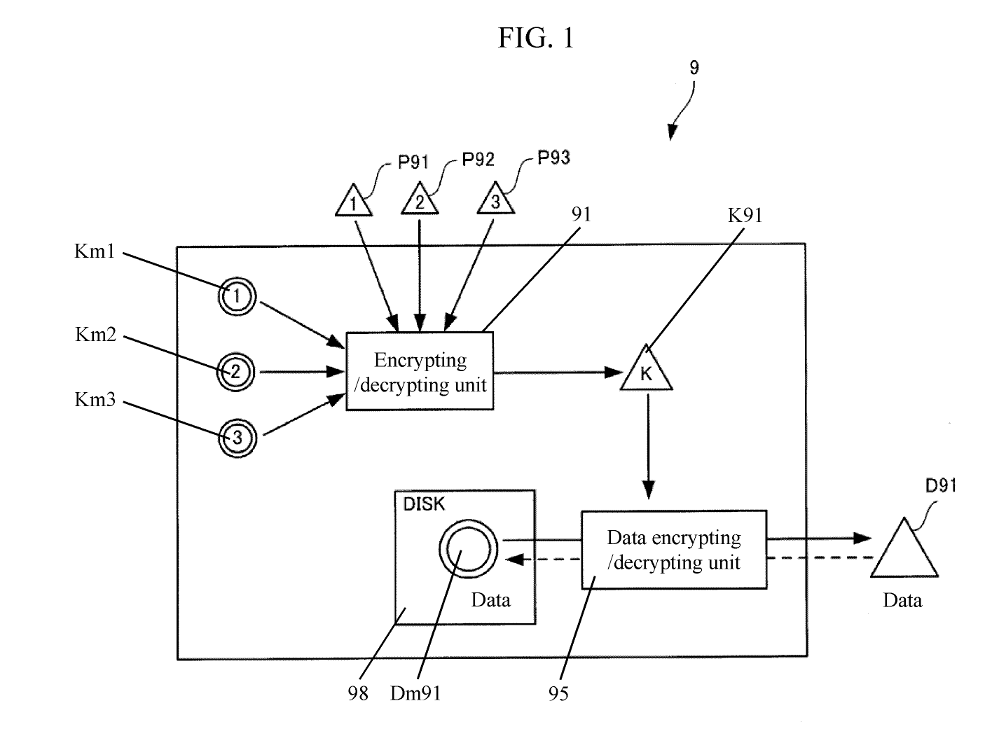

FIG. 1 is a block diagram showing the schematic structure of a hard disk drive (HDD) as an information storing device with a conventional art. In FIG. 1, double-circle denotes information on an encrypted state and triangle denotes information on a decrypted state.

Data D91 inputted externally along a broken line from the HDD 9 is encrypted by a data encrypting/decrypting unit 95 in the HDD 9 shown in FIG. 1, and is written to a magnetic disk 98 as a recording medium. The data encrypting/decrypting unit 95 encrypts/decrypts data by using a data key K91. The data key K91 is encrypted by passwords P91 to P93 allocated to a plurality of users, and is then stored to the magnetic disk 98 as encryption keys Km91 to Km93.

The data D91 stored to the HDD 9 can be externally used by the HDD 9 by inputting any of the three passwords P91 to P93.

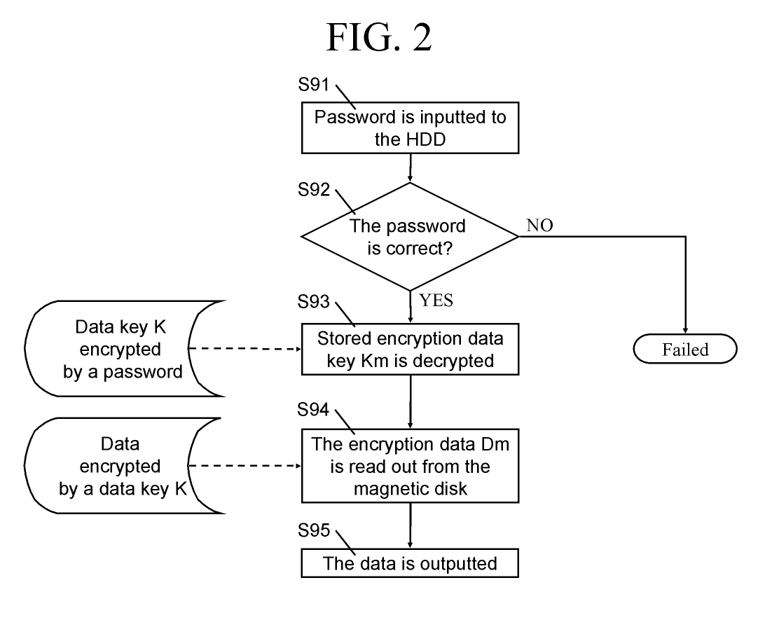

FIG. 2 is a flowchart showing processing for reading data by the HDD in FIG. 1.

In the reading processing shown in FIG. 2, a command for reading the data and a password allocated to the user is inputted to the HDD 9 from a host computer (not shown) used by the user (in step S91). The HDD 9 determines whether or not the password is correct (in step S92). When the password is correct, the stored encryption data key Km is decrypted with the password, and the data key K91 is obtained (in step S93). Thereafter, the encryption data Dm91 is read from the magnetic disk 98, and is then decrypted with the decrypted data key K91 (in step S94). The data D91 in an external available state is outputted (in step S95).

Values of the encryption data Dm91 and the data key K91 stored to the magnetic disk 98 in the HDD 9 are fixed without updating. Then, in illegal decryption of the third party, a risk for decrypting the data rises as the time passes. Therefore, the value of the data key K is preferably updated, thereby decrypting again the data on the magnetic disk.

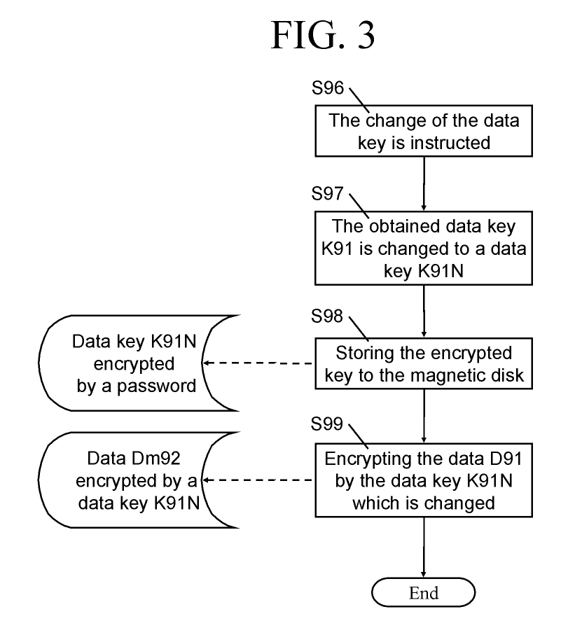

FIG. 3 is a flowchart showing processing for changing the data key in the HDD shown in FIG. 1.

The change of the data key is instructed (in step S96). Then, the HDD 9 decrypts the encryption data key Km 91 by using one of a password inputted in response to the instruction, i.e., the three passwords P91 to P93, the current data key K91 is obtained, and the obtained data key K91 is changed to a data key K91N having another value (in step S97).

The HDD 9 encrypts the changed data key K91N by using the inputted password, and stores the encrypted key to the magnetic disk 98 (in step S98). Further, the encryption data Dm91 stored to the magnetic disk 98 is temporarily read, is then decrypted by the data key K91 before changing, is encrypted by the changed data key K91N, and is stored to the magnetic disk 98 (in step S99). As mentioned above, the change of the data key and re-encryption of the data end.

However, the data key is changed in the processing shown in FIG. 3. Then, there is a problem that the change of the data key is applied only to the inputted password.

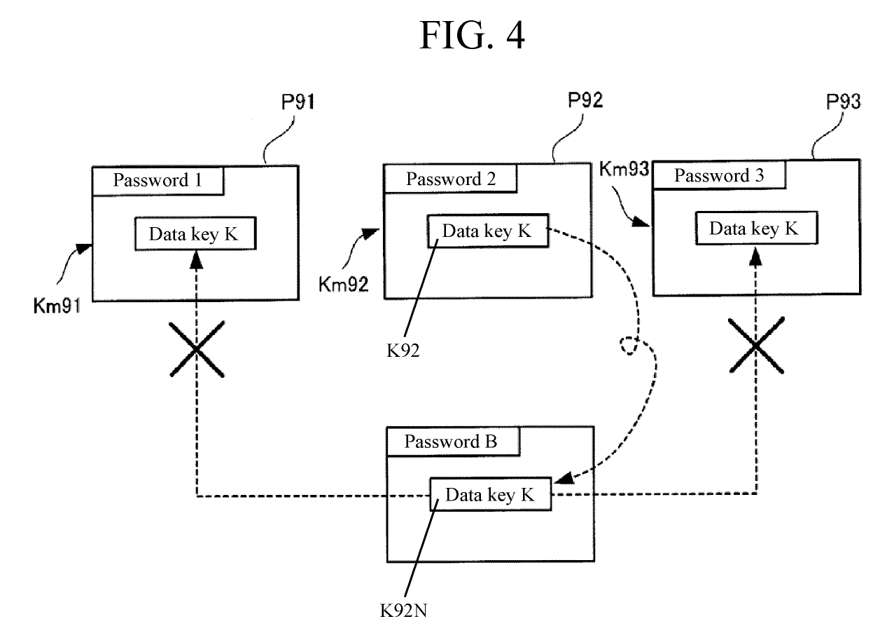

FIG. 4 is an explanatory diagram of the encrypting state of the data key in the HDD shown in FIG. 1. The key arranged in a frame of the password in FIG. 4 indicates that the key is encrypted by the password.

In the processing for changing the data key as mentioned with reference to FIG. 3, upon inputting the password P92 of the three passwords P91, P92, and P93, the encryption data key Km92 can be decrypted by using the inputted password P92, and the value of the obtained data key K92 can be changed. Although the data key K92N whose value is changed can be encrypted and stored with the inputted passwords P92, the data key K92N cannot be encrypted with the remaining passwords P91 and P93 that are not inputted. As a consequence, one of a plurality of users having passwords embodies the processing for changing the data key in the HDD 9, new data keys of the remaining users cannot be obtained, and data in the magnetic disk cannot be used.

Unlike the network system, an information storing device that is used as an auxiliary device of the computer has one password that can be simultaneously inputted, and does not keep and manage the password. Therefore, a new data key cannot be re-encrypted with a password other than the inputted passwords P92.

Hereinafter, a description will be given of the information storing device with the basic structure and the applying structure thereof according to an embodiment with reference to the drawings.

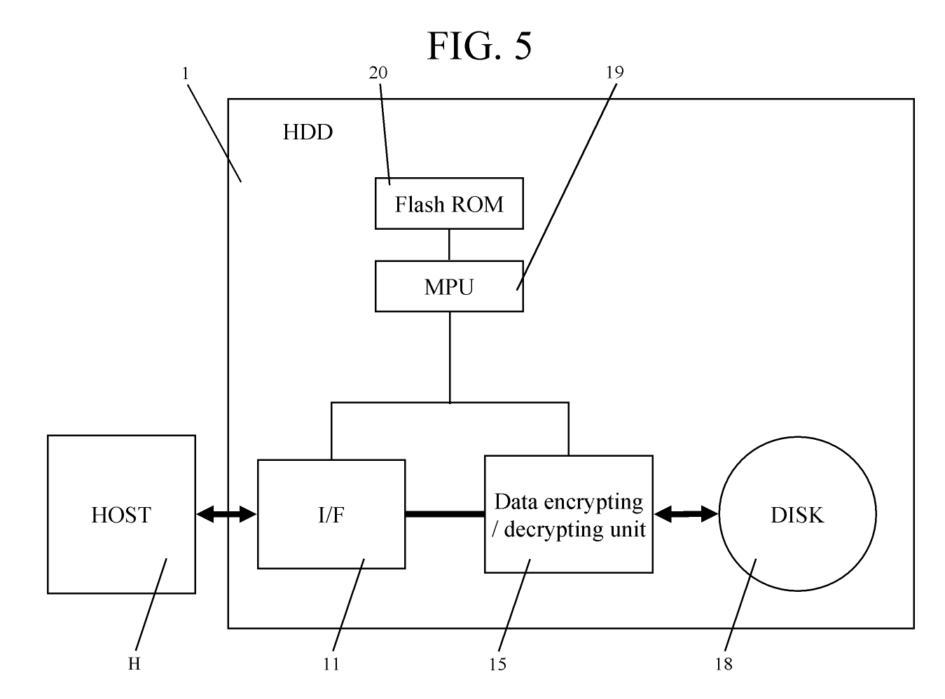

FIG. 5 is a block diagram showing the hardware structure of an HDD in the information storing device according to the embodiment.

An HDD 1 shown in FIG. 5 is used by connection to a host computer H, stores data transmitted from the host computer H, and reads the data stored and outputs the read data to the host computer H.

The HDD 1 comprises: an interface (I/F) for receiving and transmitting data and a command from/to the host computer H 11; a data encrypting/decrypting unit 15 that encrypts and decrypts the data; a magnetic disk 18 to which the data is recorded; an MPU(Micro Processing Unit) 19 as a control unit; and a flash ROM 20.

The I/F 11 receives, from the host computer H, a data writing command, a data reading command, and a key updating command. The MPU 19 controls units in the HDD 1 in response to the command received by the I/F 11 and executes processing.

In the case of the data writing command, data received in response to the command is encrypted by using a key in the data encrypting/decrypting unit 15. The encrypted data is written to the magnetic disk 18. Further, in the case of receiving the data reading command, the data read from the magnetic disk 18 is decrypted by using a key in the data encrypting/decrypting unit 15, and the decrypted data is outputted from the I/F 11 to the host computer H.

The flash ROM 20 stores firmware and a constant as a program executable by the MPU 19. The MPU 19 executes the firmware stored in the flash ROM 20, thereby executing various processing. The flash ROM 20 also stores a variable.

The data encrypting/decrypting unit 15 encrypts and decrypts the data. The data encrypting/decrypting unit 15 uses AES (Advanced Encryption Standard) for encryption and decryption and can alternatively use an algorithm of another common-key system such as triple DES in addition to AES.

A password is transmitted to the HDD 1 from the host computer H. Then, the data writing command and the data reading command are transmitted to the HDD 1 from the host computer H. The MPU 19 generates a common key supplied to the data encrypting/decrypting unit 15 by using the password transmitted from the host computer H. In the HDD 1, data can be commonly used by a plurality of users. Different passwords are allocated to the users. All users to which the passwords are allocated can read and use the data stored to the HDD 1 by another user. The host computer H transmits the password corresponding to the user who uses the host computer H to the HDD 1 together with the data writing command and the data reading command. The MPU in the HDD 1 generates a common shared key supplied to the data encrypting/decrypting unit 15 from all the allocated passwords. Further, the MPU 19 updates the shared key in response to the key updating command, and updates the data stored to the magnetic disk 18 to contents encrypted with the shared key changed. Incidentally, the HDD 1 comprises a drive device that drives the magnetic disk 18 and a RAM that stores operation data of the MPU 19. However, the components and well-known parts and functions will not be specifically described and the drawings thereof will be omitted.

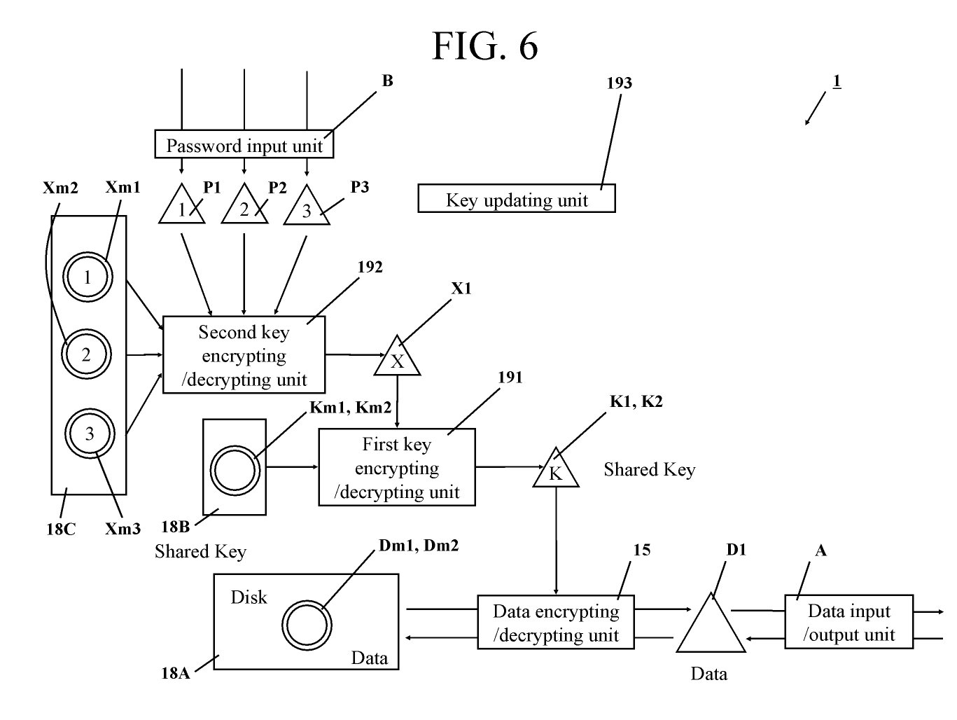

FIG. 6 is a bloc diagram showing the schematic structure of blocks for encryption/decryption in the HDD shown in FIG. 5. A double-circle in FIG. 6 denotes the encrypted information, and a triangle denotes the encrypted information.

The HDD 1 comprises: a data input/output unit A that receives and transmits the data to an external host computer H of the HDD 1; a password input unit B that receives the password from the host computer H; a data encrypting/decrypting unit 15 that encrypts and decrypts the data; an information storing unit 18A that stores the encrypted data; a first-key encrypting/decrypting unit 191 that encrypts and decrypts a shared key K1 used for encryption/decryption in the data encrypting/decrypting unit 15; a first key storing unit 18B stores an encrypting shared key Km1 encrypted by the first-key encrypting/decrypting unit 191; a second-key encrypting/decrypting unit 192 that encrypts and decrypts an intermediate key X1 used for encrypting and decrypting the shared key K1; a second-key storing unit 18C that stores the encrypted intermediate keys Xm1 to Xm3; and a key updating unit 193 that updates the key. The information storing unit 18A, the first key storing unit 18B, and the second-key storing unit 18C comprise the magnetic disk 18 shown in FIG. 5, corresponding to different storage areas on the magnetic disk 18. The first-key encrypting/decrypting unit 191, the second-key encrypting/decrypting unit 192, and the key updating unit 193 comprise the MPU 19 (FIG. 5) that executes corresponding processing. Further, the password input unit B comprises a portion for receiving the password of the MPU 19 (FIG. 5) that executes the corresponding processing and the I/F 11 shown in FIG. 5. Further, the data input/output unit A comprises a portion for receiving the data of the I/F 11 shown in FIG. 5.

The data input/output unit A receives data D from the host computer H in the data writing processing, and supplies the data D to the data encrypting/decrypting unit 15. Further, the data input/output unit A outputs, to the host computer H, the information generated by the data encrypting/decrypting unit 15 in the data reading processing.

The data encrypting/decrypting unit 15 encrypts data D1 received from the host computer H by the data input/output unit A in the data writing processing of the HDD 1, encrypts the data D1 with the shared key K1, and generates encryption data. The encryption data Dm1 encrypted by the data encrypting/decrypting unit 15 is stored to the information storing unit 18A. Further, the data encrypting/decrypting unit 15 receives the shared key K1 in the data reading processing of the HDD 1, decrypts the encryption data Dm1 stored in the information storing unit 18A with the shared key K1, and generates the data D1. The decrypted data D1 is transmitted to the data input/output unit A. As mentioned above, the shared key K1 is used for encryption and decryption in the data encrypting/decrypting unit 15. Herein, the encryption function of the data encrypting/decrypting unit 15 corresponds to an example of the information encrypting unit in the basic structure, and the decrypting function of the data encrypting/decrypting unit 15 corresponds to an example of the information decrypting unit in the basic structure. Further, the shared key K1 corresponds to an example of the first key in the basic structure.

The first key storing unit 18B stores the encrypting a shared key Km1 obtained by encrypting the shared key K1 with the intermediate key X1.

The first-key encrypting/decrypting unit 191 decrypts the encrypting shared key Km1 stored in the first key storing unit 18B with the intermediate key X1, thereby generating the shared key K1. The generated shared key K1 is inputted to the data encrypting/decrypting unit 15. Further, the first-key encrypting/decrypting unit 191 encrypts the shared key upon updating the shared key K1. As an algorithm for encrypting and decrypting the first-key encrypting/decrypting unit 191, e.g., an algorithm of another common-key system such as triple DES can be alternatively used in addition to AES. The intermediate key X1 is used for encrypting and decrypting the shared key K1. Herein, the first-key encrypting/decrypting unit 191 corresponds to an example of the first-key decrypting unit in the basic structure. Further, the intermediate key X1 corresponds to an example of the second key in the basic structure.

The second-key storing unit 18C stores a plurality of encryption intermediate keys Xm (Xm1, Xm2, Xm3) obtained by encrypting the intermediate key X1 with a plurality of passwords P (P1, P2, and P3). The first encryption intermediate key Xm1 is obtained by encrypting the intermediate key X1 with the first password P1, the second encryption intermediate key Xm2 is obtained by encrypting the intermediate key X1 with the second password P2, and the third intermediate key Xm3 is obtained by encrypting the intermediate key X1 with the third password P3.

The password input unit B inputs the passwords P1, P2, and P3 transmitted from the host computer H to the second-key encrypting/decrypting unit 192.

The second-key encrypting/decrypting unit 192 decrypts any of the encryption intermediate keys Xm1 to Xm3 stored in the second-key storing unit 18C encrypted with the inputted password with the password and generates the intermediate key X1. The encryption intermediate keys Xm1, Xm2, and Xm3 are obtained by encrypting the intermediate key X1 with the corresponding one of the passwords P1, P2, and P3, and are decrypted with the corresponding one of the passwords P1, P2, and P3 on the contrary of the decryption so as to obtain the common intermediate key X1. The generated intermediate key X1 is inputted to the first-key encrypting/decrypting unit 191. As an algorithm for encrypting and decrypting the second-key encrypting/decrypting unit 192, e.g., AES is used and an algorithm of another common-key system such as triple DES can be alternatively used in addition to AES. The passwords P1, P2, and P3 are used for encrypting and decrypting the intermediate key X1. Herein, the second-key encrypting/decrypting unit 192 corresponds to an example of the second-key decrypting unit in the basic structure. Further, the passwords P1, P2, and P3 correspond to examples of the third key in the basic structure.

The key updating unit 193 receives the key updating command, and generates a new shared key K2 in place of the shared key K1. The data encrypting/decrypting unit 15 encrypts the data generated with the original shared key K1 with the new shared key K2, and the encryption data Dm1 stored in the information storing unit 18A is rewritten with the new data Dm2. Further, the key updating unit 193 encrypts the new shared key K2 with the intermediate key X1, then generates the encrypting shared key Km2, and rewrites the encrypting shared key Km1 stored in the first key storing unit 18B. More specifically, the key updating unit 193 allows the first-key encrypting/decrypting unit 191 to encrypt the shared key K2.

Next, a description will be given of processing in the HDD 1.

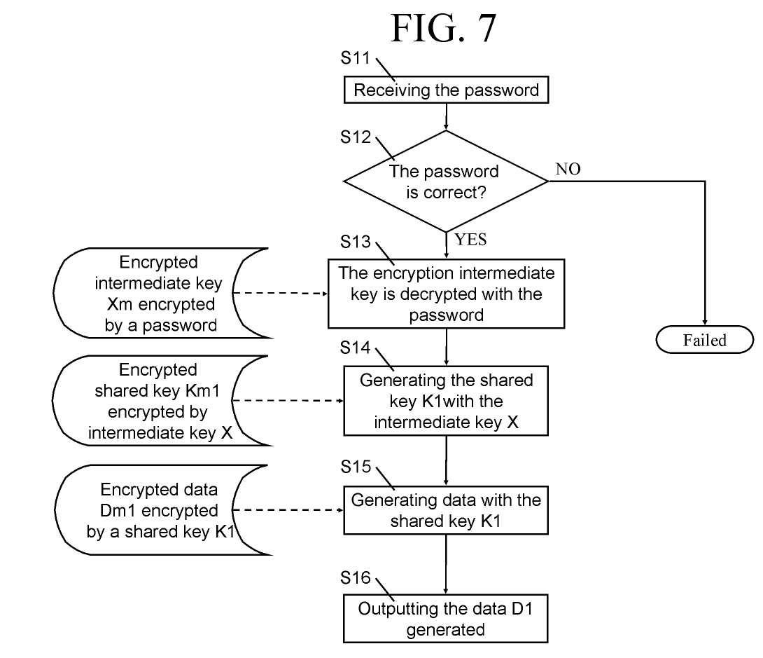

FIG. 7 is a flowchart showing processing in response to the data reading command in the HDD 1 shown in FIG. 6.

Upon transmitting the data reading command from the host computer H (refer to FIG. 5), the password is transmitted together with the data reading command. Upon receiving the password (in step S11), the password input unit B determines whether or not the received password is correct (in step S12). When it is determined that the password does not satisfy a predetermined prescription (in step S12), the fail of the command processing is notified to a host command before reading the data. As a determining method, redundant code is included in the password, and check sum and CRC are determined. In addition, the password can be encrypted by a simple method and can be stored, and the received password can be encrypted and the matching can be checked.

When it is determined the password received in the determining processing in step S12 is correct (YES in step S12), the encryption intermediate key Xm stored in the second encrypting/decrypting unit 192 is then decrypted by the second-key encrypting/decrypting unit 192 with the password, thereby generating the intermediate key X1 (in step S13).

Subsequently, the first-key encrypting/decrypting unit 191 decrypts the encrypting shared key Km1 stored in the first key storing unit 18B with the intermediate key X1 generated by the second-key encrypting/decrypting unit 192, thereby generating the shared key K1 (in step S14). Subsequently, the data encrypting/decrypting unit 15 decrypts the encryption data Dm1 stored in the information storing unit 18A with the shared key K1 generated by the first-key encrypting/decrypting unit 191, thereby generating the data D1 (in step S15).

Subsequently, the data input/output unit A outputs the data D1 generated by the data encrypting/decrypting unit 15 to the host computer H (in step S16). Thus, the data D1 is outputted in response to the reading command with the password.

The above description is given of the processing in response to the data reading command. The data writing processing in response to the data writing command is also common to the processing shown in steps S11 to S14 in FIG. 7. In the data writing processing, in place of step S15 shown in FIG. 7, the data encrypting/decrypting unit 15 encrypts the data D1 received by the data input/output unit A with the shared key K1 generated by the first-key encrypting/decrypting unit 191, thereby generating the encryption data Dm1. Further, in place of step S16 shown in FIG. 7, the information storing unit 18A stores the encryption data Dm1 encrypted by the first-key encrypting/decrypting unit 191.

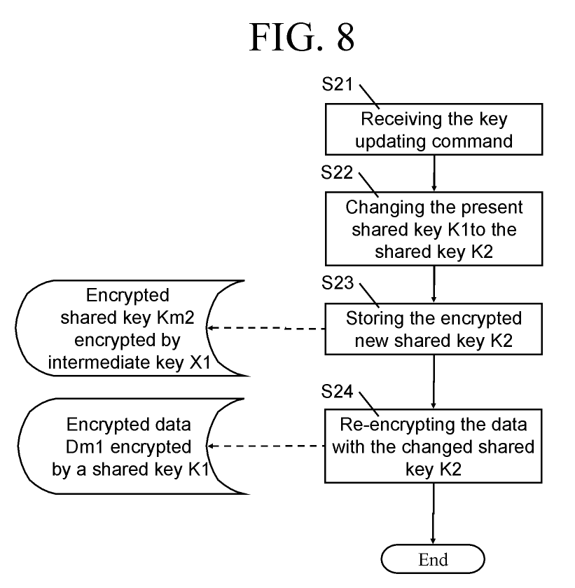

FIG. 8 is a flowchart showing processing in response to the key updating command in the HDD 1 shown in FIG. 6.

The HDD 1 receives the key updating command from the host computer H (in step S21). Then, the key updating unit 193 changes the present shared key K1 to the shared key K2 (in step S22). The key updating unit 193 more specifically generates the shared key K2 having a value different from the current shared key K1. A new value of the shared key K2 can be arbitrarily determined by a random number.

Subsequently, the key updating unit 193 encrypts a new shared key K2 with the intermediate key X1 and stores the encrypted new shared key K2 (in step S23). More specifically, the key updating unit 193 allows the first-key encrypting/decrypting unit 191 to encrypt the new shared key K2 with the intermediate key X1, thereby generating the encrypting shared key Km2 and storing the encrypting shared key Km2 to the first key storing unit 18B.

Subsequently, the key updating unit 193 re-encrypts the data with the changed shared key K2 (in step S24). More specifically, the key updating unit 193 first allows the data encrypting/decrypting unit 15 to decrypt the encryption data Dm1 1in the information storing unit 18A before changing with the shared key K1, thereby generating the data D1. The key updating unit 193 subsequently allows the data encrypting/decrypting unit 15 to encrypt the generated data D1 with the new shared key K2, thereby generating new encryption data Dm2. The key updating unit 193 further allows the information storing unit 18A to store the new encryption data Dm2. With the processing insteps S22 to S24, the shared key K2 is updated and the information in the information storing unit 18A is re-encrypted with the updated shared key K2.

The execution of the processing for updating the key as shown in FIG. 8 needs the shared key K1 so as to temporarily decrypt the encryption data Dm1 stored in the information storing unit 18A. Further, the intermediate key X1 is necessary so as to encrypt the updated shared key K1. However, the shared key K1 and the intermediate key X1 are stored in the encrypting state after turning on the HDD 1. Therefore, the processing for updating the key shown in FIG. 8 is normally executed after the power is turned on, the reading command and writing command are inputted to the HDD 1, and at least one of the plurality of passwords P1, P2, and P3 is inputted. Further, upon inputting a log-in command for inputting the password to the HDD 1, the password is also inputted. Thereafter, the processing for updating the key is normally executed.

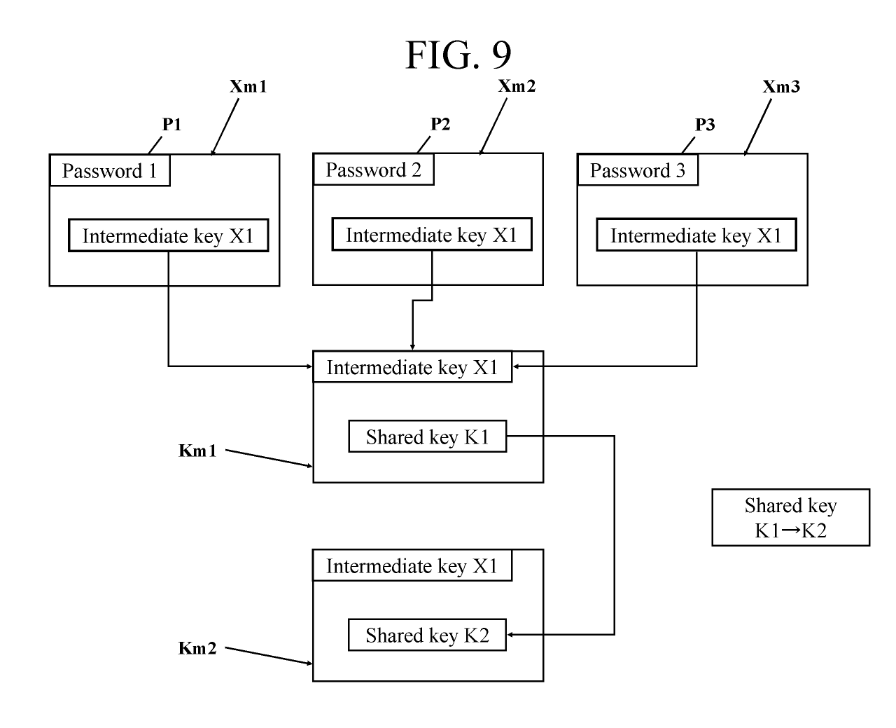

FIG. 9 is an explanatory diagram of a key encrypting state in the HDD shown in FIG. 6. Referring to FIG. 9, a frame of the intermediate key shown in a frame of the password indicates that the intermediate key is encrypted by the password. Further, a frame of the shared key shown in the frame of the intermediate key shows that the shared key is encrypted by the intermediate key.

As shown in FIG. 9, upon inputting the one password P2 of the three passwords in the processing for updating the key, the intermediate key X1 is obtained from the encryption intermediate key Xm2 with the password P2. The intermediate key X1 is common to the three passwords. If using any of the three passwords, the intermediate key X1 having the same contents is obtained. The shared key K1 is obtained from the encrypting shared key Km1 with the intermediate key X1. In the processing for updating the key shown in FIG. 8, the shared key K1 is changed to the shared key K2 having a new value, the changed common key K2 is encrypted with the intermediate key X1, and the encrypting shared key Km2 is obtained. Therefore, in the HDD 1, upon updating the encryption data Dm1 and the shared key K1 for encryption on the magnetic disk 18 with the processing for updating the key, the intermediate key X1 for the three passwords P1, P2, and P3 is not changed. Therefore, the intermediate keys Xm1 to Xm3 for encryption do not need to be changed with the passwords P1, P2, and P3. Thus, if one of a plurality of users inputs the password (e.g., P2) and performs the processing for updating the key, the reading of the data with another password of another user is performed. The user can keep the secret of the data by updating the key at an arbitrary timing, irrespective of the use of another user. A plurality of the intermediate keys X1 are accessible by a plurality of passwords, respectively. The shared key K1 for encrypting and decrypting data is encrypted to produce an encrypted shared key K1 by using the intermediate key X1. The encrypted shared key K1 is stored. The encrypted shared key K1 is decrypted by using one of the intermediate keys X1 and data is encrypted or decrypted by the shared key K1 upon receipt of a command from a host to encrypt or decrypt the data. Upon receipt of a command for renewing the shared key K1 from the host, the renewed shared key K1 is received, the renewed shared key K1 is encrypted with one of the intermediate keys X1 and the encrypted renewed shared key K1 is stored.

Next, a description will be given of an information storing device according to the second embodiment. According to the second embodiment, the same components as described above are designated by the same components, and different points from those according to the first embodiment will be described.

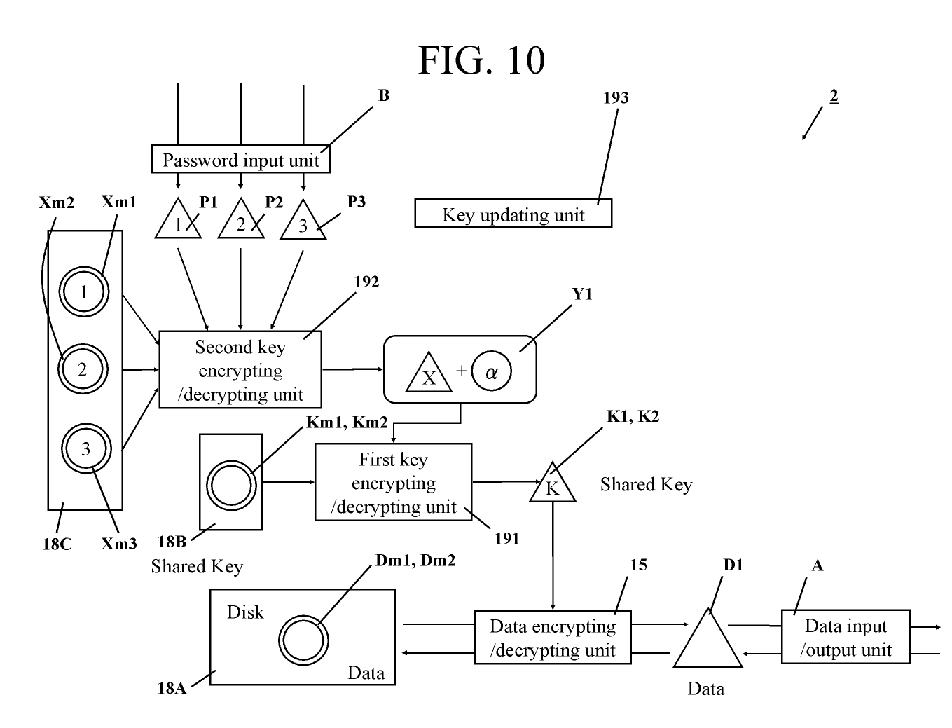

FIG. 10 is a block diagram showing of the schematic structure of blocks for encryption/decryption in an HDD according to the second embodiment.

An HDD 2 according to the second embodiment has the same hardware structure as that of the HDD 1 shown in FIG. 5 according to the first embodiment, and processing contents of an MPU are however different from those according to the first embodiment. Specifically, in the HDD 2 shown in FIG. 10, an intermediate key Y1 includes a product serial No. α as peculiar information of the HDD 2. A value varied depending on the product of the HDD 2 is given to the product serial No. α. A value of the product serial No. is stored as a part of a program in the MPU 19 to the flash ROM 20 (refer to FIG. 5).

Upon decrypting the encryption intermediate keys Xm, the second-key encrypting/decrypting unit 292 in the HDD 2 decrypts the encryption intermediate keys Xm stored in the second-key storing unit 18C with the password P, by AES. Further, the product serial No. α stored in the flash ROM 20 is added, thereby setting an intermediate key Y1. The first-key encrypting/decrypting unit 191 in the HDD 2 encrypts/decrypts the shared key with the intermediate key Y1.

Further, when a second-key encrypting/decrypting unit 292 encrypts the intermediate key Y1, the product serial No. α is excluded from the intermediate key Y1 and the encryption is performed with AES.

In the HDD 2 of the second embodiment, the intermediate key Y1 is varied depending on the products. Therefore, if the intermediate key Y1 of the HDD 2 is externally extracted by the third party with some method, the extracted intermediate key us moved, i.e., is stored to another product, the data on the magnetic disk is not normally decrypted. Therefore, the illegal use of the data can be suppressed.

According to the second embodiment, the product serial No. is included in the key necessary for generating the shared key K. Next, a description will be given of an information storing device in which information included in the key can be arbitrarily selected according to the third embodiment. Hereinbelow, according to the third embodiment, the same components as those according to the first and second embodiments are designated by the same reference numerals, and different points will be described.

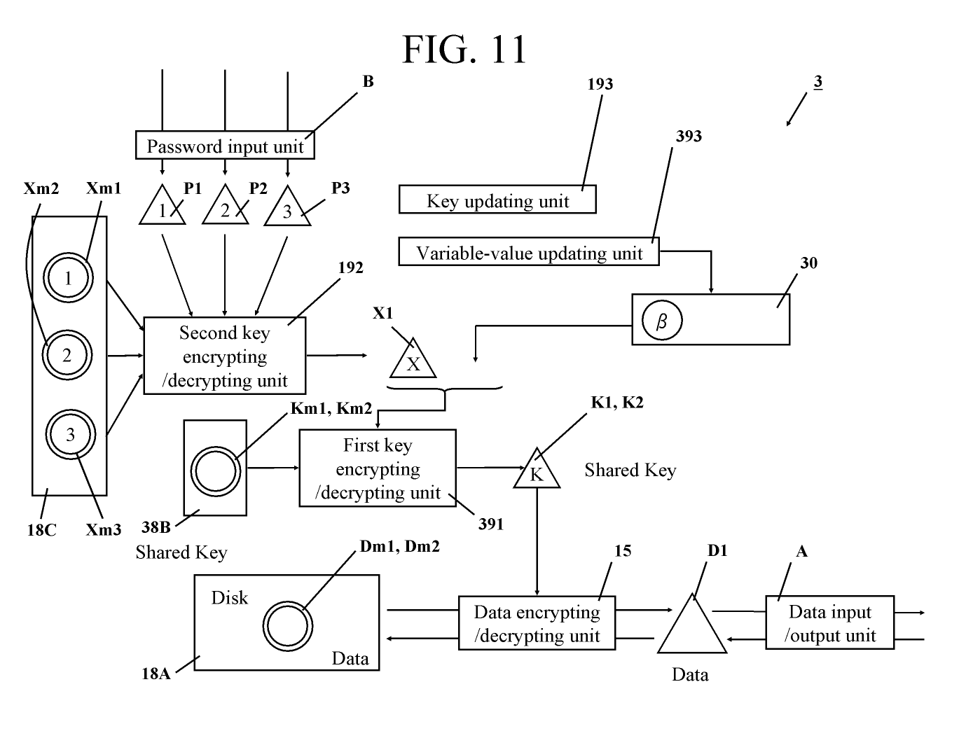

FIG. 11 is a block diagram showing the schematic structure of blocks for encryption/decryption in an HDD according to the third embodiment.

An HDD 3 according to the third embodiment has the same hardware structure as that of the HDD 1 shown in FIG. 5 according to the first embodiment. The HDD 3 shown in FIG. 11 comprises: a variable-value storing unit 30 that stores a value of an encrypting variable β as a variable used for generating the key; and a variable-value updating unit 393 that updates a value of the encrypting variable β stored in the variable-value storing unit 30. The variable-value storing unit 30 comprises the flash ROM 20 shown in FIG. 5, and an address for storing the value of the encrypting variable β is fixed. Further, the variable-value updating unit 393 comprises the MPU 19 (FIG. 5) that executes processing for updating the encrypting variable β. The variable-value updating unit 393 receives an encrypting variable command from the host computer H. Then, the variable-value updating unit 393 updates the value of the encrypting variable β of the variable-value storing unit 30 with a variable value transmitted in response to the encrypting variable command.

The encrypting shared key Km1 stored in the first key storing unit 38B in the HDD 3 is obtained by encrypting the shared key K1 with a combination of the intermediate key X1 and the encrypting variable β. Further, the first-key encrypting/decrypting unit 391 in the HDD 3 decrypts the encrypting shared key Km1 stored in the first key storing unit 38B with a combination of the intermediate key X1 and the encrypting variable β, thereby generating the shared key K1.

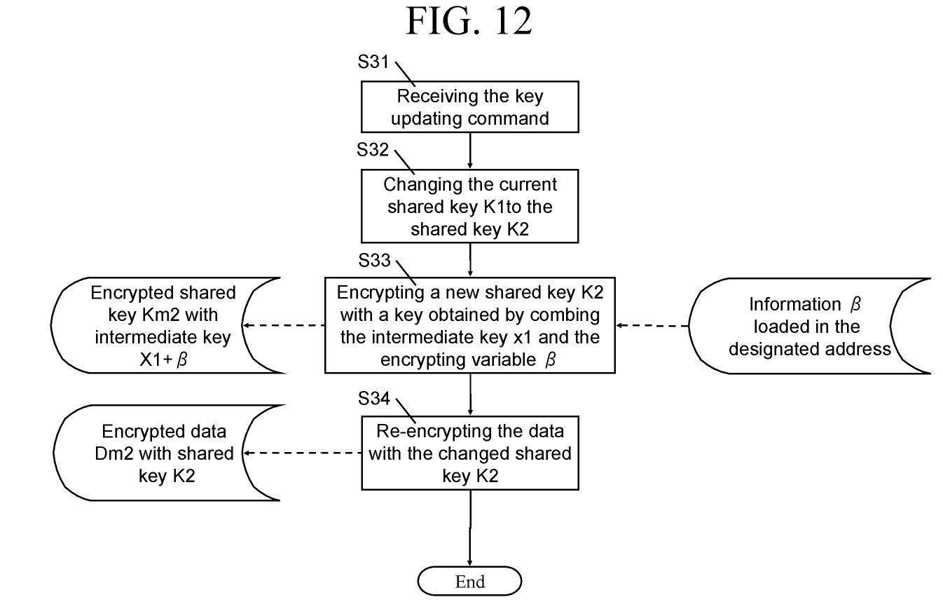

FIG. 12 is a flowchart showing processing in response to the key updating command in the HDD shown in FIG. 11.

The HDD 3 receives the key updating command from the host computer H (in step S31), and the key updating unit 193 changes the current shared key K1 to the shared key K2 (in step S32). Processing in steps S31 and S32 is similar to the processing in steps S21 and S22 shown in FIG. 8.

Subsequently, the key updating unit 193 encrypts a new shared key K2 with a key obtained by combining the intermediate key X1 and the encrypting variable 1, and stores the encrypted key (in step S33). The key updating unit 193 allows the first key storing unit 38B to store the shared key Km2 for encryption generated by the encryption.

Thereafter, the key updating unit 193 re-encrypts the data the data with the changed shared key K2 (in step S34). The processing in step S34 is similar to the processing in step S24 in FIG. 8.

In the HDD 3 according to the third embodiment, the encrypting shared key Km1 obtained by encrypting the shared key K1 with a combination of the intermediate key X1 and the encrypting variable β is stored to the first key storing unit 38B. Further, the encrypting variable β is stored to a specific address in the variable value storing unit 30, and is changed by the encrypting variable command. Therefore, the third party cannot easily analogy the encrypting variable β. Therefore, the illegal use of the data is suppressed.

Incidentally, according to the embodiments, the third embodiment in which the intermediate key and the encrypting variable β are combined and the second embodiment in which the intermediate key includes the product serial No. α are described as different ones. However, the encrypting variable β and the product serial No. α may be combined, that is, the product serial No. α may be included in the intermediate key and a key obtained by combining the intermediate key and the encrypting variable β may be used as a decryption key.

Further, according to the embodiments, the three passwords P1, P2, and P3 are described as a plurality of third keys in the basic structure. Furthermore, the number of the third keys is not limited to three and may be alternatively two or no-less-than four.

In addition, according to the embodiments, the example of the HDD is described as the information storing device in the basic structure and the applying structure. Alternatively, the information storing device is not limited to the HDD, and may be a device having a magneto-optical disk device or another recording medium.

In addition, according to the embodiments, as the first-key decrypting unit and the second-key decrypting unit in the basic structure, the examples of the operation with the data reading processing and the data writing processing are described. However, in order to prevent the decryption of the first key and the second key every data reading processing and every data writing processing, in the first-key decrypting unit and the second-key decrypting unit, the processing in steps S12 to S14 shown in FIG. 7 of the data reading processing may be executed as independent log-in processing and the decrypted key may be stored to the RAM. In this case, the remaining processing is executed as the data reading processing, and the log-in processing is performed once. Then, the data reading and writing operations can be performed without re-inputting the password until shutting-off the power.

As mentioned above, with the basic structure of the information storing device, upon updating the key, the information and the first key stored to the information storing unit are updated without changing a plurality of third keys allowed to users.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A method of controlling a memory device connectable to a host for sending out a command to the memory device, the method comprising:
storing a plurality of first keys which are accessible by a plurality of passwords, respectively;
encrypting a second key for encrypting and decrypting data to produce an encrypted second key by using one of the first keys, and storing the encrypted second key;
decrypting the encrypted second key by using one of the first keys and encrypting or decrypting data by the second key upon receipt of a command from the host to encrypt or decrypt the data; and
receiving, upon receipt of a command for renewing the second key from the host, a renewed second key, encrypting the renewed second key with one of the first keys, and storing the encrypted renewed second key.

2. The method of claim 1, further comprising encrypting data by using the renewed second key.

3. The method of claim 2, further comprising decrypting the encrypted renewed second key by using the first key and decrypting the data by using the renewed second key.

4. The method of claim 1, wherein the renewed second key includes peculiar information peculiar to the memory device.

5. The method of claim 1, further comprising storing a variable value.

6. The method of claim 5, further comprising encrypting the renewed second key on the basis of the variable value.

7. A memory device connectable to a host for sending out a command to the memory device, comprising:
a storage that stores a plurality of first keys which are accessible by a plurality of passwords, respectively; and
a processor that encrypts a second key for encrypting and decrypting data to produce an encrypted second key by using one of the first keys, and stores the encrypted second key, decrypts the encrypted second key by using one of the first keys and encrypts or decrypts data by the second key upon receipt of a command from the host to encrypt or decrypt the data and receives, upon receipt of a command for renewing the second key from the host, a renewed second key, encrypts the renewed second key with one of the first keys, and stores the encrypted renewed second key.

8. The memory device of claim 7, wherein the processor encrypts data by using the renewed second key.

9. The memory device of claim 8, wherein the processor decrypts the encrypted renewed second key by using the first key and decrypts the data by using the renewed second key.

10. The memory device of claim 7, wherein the renewed second key includes peculiar information peculiar to the memory device.

11. The memory device of claim 7, wherein the storage stores a variable value.

12. The memory device of claim 11, wherein the processor encrypts the renewed second key on the basis of combining the variable value.
